(19) United States
(12) Patent Application Publication
(10) Pub. No.: US 2024/0349705 A1
(43) Pub. Date: Oct. 24, 2024

(54) WATER-CHANGING-FREE TERRARIUM WITH PIPELINE TYPE BIOFILTRATION SYSTEM

(71) Applicant: Cheung Foo LAM, Hong Kong (CN)

(72) Inventor: Cheung Foo LAM, Hong Kong (CN)

(21) Appl. No.: 18/677,929

(22) Filed: May 30, 2024

Related U.S. Application Data
(63) Continuation of application No. PCT/CN2024/088149, filed on Apr. 17, 2024.

(30) Foreign Application Priority Data
Apr. 18, 2023 (CN) 2023104133266

(51) Int. Cl. A01K 63/00

(52) U.S. Cl. CPC A01K 63/006

(57) ABSTRACT

A water-changing-free terrarium with pipeline type biofiltration system is provided, which includes: a terrarium body; a box body, disposed in the terrarium body and fixedly connected to a bottom of the terrarium body; a filtration assembly, disposed in the box body. The box body is provided with a first partition and a second partition therein, which are perpendicular to a bottom of the box body, and the first partition and the second partition are fixedly connected to the bottom of the box body. A filtration groove is defined between the first partition and the second partition, and is provided with filtration cotton therein. Through the filtration assembly, most impurities in the water are filtered and decomposed in the modified filter material. The purified water flows back to the terrarium through the outlet pipe, and other undecomposed impurities are adsorbed on the filtration cotton, which is beneficial for subsequent centralized cleaning.

### CROSS-REFERENCE TO RELATED APPLICATIONS

This application is a continuation of International Patent Application No. PCT/CN2024/088149, filed on Apr. 17, 2024, which claims the priority of Chinese Patent Application No. 202310413326.6, filed on Apr. 18, 2023, both of which are herein incorporated by reference in their entirety.

### TECHNICAL FIELD

The disclosure relates to the technical field of terrariums, and more particularly to a water-changing-free terrarium with a pipeline type biofiltration system.

### BACKGROUND

Nowadays, people like to keep pets in their spare time from work. Fish and turtles are common pets, and both fish and turtles cannot be kept without a fish tank. In a process of raising the fish or the turtles, changing water is quite troublesome. If water is not changed for a long time, there will be a lot of food residues and excrement in the water, as well as a lot of water mold and algae, which not only reduces ornamental value but also emits a stimulating taste.

A necessary environment for fish to survive is water, and the survival of fish is closely related to water quality. Everyone who raises fish highly recognizes the saying “raise water first when raising fish”, so it is particularly crucial to manage the water quality well when managing ornamental fish tanks in daily life. Many consumers often lose interest in raising fish in a short period of time because they cannot manage the water quality well, resulting in fish dying shortly after being raised. According to market research, reasons for rapid fish death in the fish tanks include deteriorating water quality, improper tank management, and lack of experience. Therefore, in the water quality management, daily management of the fish tanks is a crucial and challenging task. In order to maintain good water quality in the fish tanks, it is necessary to improve the quality of the water quality management.

A Chinese patent with an application No. 201811457127.0 (corresponding to publication No.: 109349198) discloses an automatic-water-purification environment-friendly fish tank, and in the fish tank, a connecting vessel device is composed of a first circulating tank with a fish tank body, and the fish tank body with a second circulating tank through a first U-shaped pipe and a second U-shaped pipe; during heating, as a local water temperature of the first circulating tank and a local water temperature of the second circulating tank are larger than a water temperature of the fish tank body, convection is formed through a first circulating opening and a second circulating opening, and water in the first circulating tank and water in the second circulating tank enter the fish tank body; when convection is carried out, water at a bottom of the fish tank body enters the first circulating tank and the second circulating tank through the first U-shaped pipe and the second U-shaped pipe, water in the fish tank is effectively purified through filters and purification boxes on the first U-shaped pipe and the second U-shaped pipe, automatic purification circulating is formed, other assisting devices are not used, the water in the fish tank is automatically and continuously purified, a period of changing water of the fish tank is prolonged, and aims of environmentally friendly and saving water are achieved. The automatic-water-purification environment-friendly fish tank is simple in structure, high in practicability and easy to apply and popularize. A Chinese patent with an application No. 202111578556.5 (corresponding to publication No.: 113951207) discloses a fish tank water treatment device and fish tank, including: a cavity and a suction source. The cavity is provided with a bottom suction port and a water outlet. The suction source sucks fluid into the cavity from the bottom suction port, and the fluid flows out of the cavity from a water outlet. The bottom suction port is disposed in a side wall of the cavity and is at least one vertical strip-shaped hole. A water retaining piece is disposed on the strip-shaped hole, and a lower half part of the strip-shaped hole is selectively blocked by the water retaining piece. A blocking medium is disposed between the bottom suction port and the water outlet or on the water outlet, so that the fluid flows to the water outlet with resistance. According to the fish tank water treatment device, by means of the bottom suction port, excrement, food residues and other dirt at a bottom of the fish tank can be sucked in, bottom sand or other particles can be blocked, a water inlet position of the bottom suction port can be adjusted according to needs, meanwhile, the dirt can be retained in the cavity through the fluid with resistance, and follow-up concentrated cleaning is facilitated.

The above patents all improve a structure of the fish tank body to purify the water inside the fish tank. However, for fish tanks with already formed structures, adding these water purification devices is costly and not conducive to promotion and use.

### SUMMARY

Aiming at disadvantages of the related art, a purpose of the disclosure is to provided a water-changing-free terrarium with a pipeline type biofiltration system, the terrarium has features of wide versatility and can filter and decompose impurities such as floating debris, fish manure, and residues in water, and purified water can be recycled back into the terrarium, to thereby achieve internal water circulation purification.

In order to achieve the above purpose, the disclosure provides the following technical solutions.

A water-changing-free terrarium with a pipeline type biofiltration system includes: a terrarium body, a box body, a first partition, a second partition, a filtration assembly and filtration cotton. The box body is disposed in the terrarium body and is fixedly connected to a bottom of the terrarium body. The filtration assembly is disposed in the box body. The first partition and the second partition are disposed in the box body and perpendicular to a bottom of the box body, and the first partition and the second partition are fixedly connected to the bottom of the box body. A filtration groove is defined between the first partition and the second partition, and the filtration groove is provided with the filtration cotton therein.

In an embodiment, the filtration assembly includes: a water pump, a horizontal pipeline, multiple vertical pipelines, an outlet pipe and a pipeline. The water pump is disposed on a left side of the first partition, and is fixedly connected to the bottom of the box body, and a water inlet of the water pump is in communication with the filtration groove through the pipeline. The horizontal pipeline is disposed on a bottom-right of the second partition, and the horizontal pipeline penetrates through the second partition and is in communication with the filtration groove. The multiple vertical pipelines are disposed on a top of the horizontal pipeline, an end of each of the multiple vertical pipelines is in communication with the horizontal pipeline, and the multiple vertical pipelines are perpendicular to the bottom of the box body. The outlet pipe is in communication with a water outlet of the water pump.

In an embodiment, a right side of the second partition is filled with a modified filter material, and an upper part of the modified filter material is configured to be provided with a submerged plant.

The submerged plant includes at least one selected from the group consisting of Myriophyllum verticillatum, Potamogeton wrightii, Vallisneria natans, and Hydrilla verticillata.

In an embodiment, a preparation method of the modified filter material includes:
(a) mixing maifanstone powder and zeolite powder evenly to obtain mixing powder, soaking the mixing powder in diluted hydrochloric acid to obtain a soaked mixture, and calcining the soaked mixture to obtain pretreated mixing powder;
(b) adding the pretreated mixing powder obtained in the step (a) into deionized water, adding a chitosan solution, sodium bicarbonate and γ-glycidoxypropyltrimethoxysilane into deionized water added with the pretreated mixing powder, stirring the deionized water added with the pretreated mixing powder, the chitosan solution, the sodium bicarbonate and the γ-glycidoxypropyltrimethoxysilane for reaction to obtain a first mixture, filtering the first mixture to obtain a first filtered mixture, and drying the first filtered mixture to obtain filter material powder;
(c) mixing the filter material powder obtained in the step (b) with cement evenly to obtain a second mixture, adding the second mixture into deionized water for stirring evenly to obtain a third mixture, performing granulation molding on the third mixture to obtain a molded mixture, and roasting on the molded mixture to obtain filter material particles; and
(d) adding the filter material particles obtained in the step (c) into a compound bacterial solution for oscillating at room temperature for 2-4 hours (h) to obtain an oscillated mixture, adding soluble pentosan into the oscillated mixture for stirring evenly, adding a potassium chloride solution and pentaerythritol tetra acrylate into oscillated mixture added with the soluble pentosan to obtain a fourth mixture, performing a crosslinking reaction on the fourth mixture to obtain a crosslinked mixture, filtering the crosslinked mixture to obtain a second filtered mixture, and drying the second filtered mixture at the room temperature, to obtain the modified filter material.

In an embodiment, in the step (a), a weight ratio of the maifanstone powder and the zeolite powder is in a range of 1:0.5-2; a weight concentration of the diluted hydrochloric acid is in a range of 3-7%; a period for the soaking is in a range of 2-4 h; and a temperature for the calcining is in a range of 400-600 Celsius degree (° C.), and a period for the calcining is in a range of 1-3 h.

In an embodiment, in the step (b), a weight concentration of the chitosan solution is in a range of 30-60 grams per liter (g/L); a weight ratio of the pretreated mixing powder:the chitosan solution:the sodium bicarbonate:the γ-glycidoxypropyltrimethoxysilane is in a range of 50:100-150:5-8:2-4; and a temperature for the stirring is in a range of 50-60° C., and a period for the stirring is in a range of 4-6 h.

In an embodiment, in the step (c), a weight ratio of the filter material powder: the cement: the deionized water is in a range of 10:1-1.5:2-4; and a temperature for the roasting is in a range of 350-500° C., and a period for the roasting is in a range of 2-5 h.

In an embodiment, in the step (d), the compound bacterial solution is a mixing solution of Bacillus subtilis and nitrifying bacteria, and strain concentrations of the Bacillus subtilis and the nitrifying bacteria are 3-5×10¹⁰ per milliliter (/mL) and 1-2×10¹⁰/mL, respectively; a weight concentration of the potassium chloride solution is in a range of 2-4%; a weight ratio of the filter material particles: the soluble pentosan: the potassium chloride solution: the pentaerythritol tetra acrylate is in a range of 50:3-5:100-200:1-2; and a temperature for the crosslinking reaction is in a range of 20-30° C., and a period for the crosslinking reaction is in a range of 5-8 h.

In an embodiment, a height of a water surface of the terrarium body is lower than a height of the outlet pipe; and a top of the filtration groove is provided with a detachable sealing cover plate, and the detachable sealing cover plate is configured to replace the filtration cotton.

In an embodiment, a number of the filtration assembly is at least one, and the outlet pipe is inverted L-shaped.

Compared to the related art, the disclosure has the following beneficial effects.

(1) In the water-changing-free terrarium with the pipeline type biofiltration system provided by the disclosure, the modified filter material is prepared by the following steps. The zeolite and the maifanstone are treated with acid and then treated at high temperature, the acid treatment improves pore structures of the zeolite and the maifanstone, and the high-temperature treatment causes certain chemical changes in crystalline structures of the maifanstone and the zeolite, these treatments enhance adsorption capacities of the maifanstone and the zeolite. Then the chitosan is grafted onto a surface of the mixing powder of the zeolite and the maifanstone, to further improve a load capacity of the mixing powder. Then the cement, as an adhesive, is added into the mixing powder (i.e., the filter material powder), under roasting, the sodium bicarbonate is decomposed to generate gas, so that the filter material particles form numerous pore structures, to thereby provide a large attachment area for microorganisms. Finally, the microorganisms on surfaces of the filter material particles are embedded with the soluble pentosan, which effectively improves adhesion of the microorganisms on a surface of the filter material, and improves a service life of the filter material. The pentosan has a good adsorption performance, and has a certain adsorption effect for impurities and ammonia nitrogen in water, so as to accelerate a degradation efficiency of the microorganisms on the impurities such as fish manure and residues in the terrarium.

(2) In the water-changing-free terrarium with the pipeline type biofiltration system provided by the disclosure, through the filtration assembly on the bottom of the terrarium, most impurities such as floating objects, fish droppings and residues in the water are filtered, and are decomposed in the modified filter material. The purified water flows back to the terrarium through the outlet pipe, and other undecomposed impurities are adsorbed on the filtration cotton, which is beneficial for subsequent centralized cleaning, and through changing the filtration cotton regularly, the water quality in the terrarium can be purified.

### BRIEF DESCRIPTION OF DRAWINGS

FIG. 1 illustrates a schematic structural diagram of a water-changing-free terrarium with a pipeline type biofiltration system according to an embodiment 1 of the disclosure.

FIG. 2 illustrates a schematic top diagram of a filtration assembly of the water-changing-free terrarium with the pipeline type biofiltration system according to the embodiment 1 of the disclosure.

### LIST OF REFERENCE NUMBERS

1—terrarium body; 2—box body; 3—first partition; 4—second partition; 5—filtration groove; 6—filtration assembly; 7—water pump; 8—horizontal pipeline; 9—vertical pipeline; 10—outlet pipe; 11—modified filter material; 12—filtration cotton; 13—water surface; 14—water inlet; 15—pipeline; 16—water outlet; 17—detachable sealing cover plate.

### DETAILED DESCRIPTION OF EMBODIMENTS

Technical solutions in embodiments of the disclosure are clearly and completely descried in conjunction with drawings in the embodiments of the disclosure. Apparently, the described embodiments are merely some of the embodiments of the disclosure, not all of them. Based on the embodiments of the disclosure, other embodiments obtained by those skilled in the art without creative work fall within a scope of protection of the disclosure.

Maifanstone powder (also referred to as medical stone powder) is purchased from Hebei Mingzhe Mineral Products Co., Ltd., and a mesh size of the maifanstone powder is 200 mesh. Zeolite powder is purchased from Xinyang Houpu Mining Co., Ltd., and a mesh size of the zeolite powder is 325 mesh. Chitosan is purchased from Xi'an Pres Biotechnology Co., Ltd., and is soluble chitosan, and a chemical abstract service (CAS) number of the chitosan is 90112-76-4. Cement is 42.5 ordinary portland cement. Soluble pentosan is purchased from Shaanxi Pioneer Biotech CO., Ltd., and is soluble pentosan. Bacillus subtilis is purchased from Cangzhou Huayu Biotechnology Co., Ltd., and a bacterial concentration of the Bacillus subtilis is 20 billion/g. Nitrifying bacteria is purchased from Hubei Zhongyan Biotechnology Co., Ltd., and a bacterial concentration of the nitrifying bacteria is 20 billion/g.

### Embodiment 1

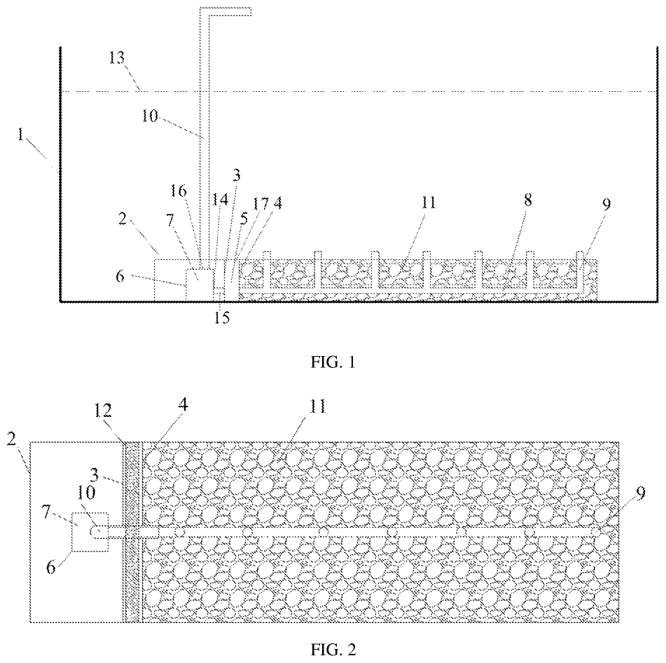

As shown in FIG. 1 and FIG. 2, a water-changing-free terrarium with a pipeline type biofiltration system is provided, and the water-changing-free terrarium includes a terrarium body 1, a box body 2, a first partition 3, a second partition 4, a filtration assembly 6 and filtration cotton 12. The box body 2 is disposed in the terrarium body 1 and is fixedly connected to a bottom of the terrarium body 1. The filtration assembly 6 is disposed in the box body 2. The first partition 3 and the second partition 4 are disposed in the box body 2 and perpendicular to a bottom of the box body 2, and the first partition 3 and the second partition 4 are fixedly connected to the bottom of the box body 2. A filtration groove 5 is defined between the first partition 3 and the second partition 4, and the filtration groove 5 is provided with the filtration cotton 12 therein.

In the embodiment, the filtration assembly 6 includes: a water pump 7, a horizontal pipeline 8, vertical pipelines 9, an outlet pipe 10 and a pipeline 15. The water pump 7 is disposed on a left side of the first partition 3, and is fixedly connected to the bottom of the box body 2, and a water inlet 14 of the water pump 7 is in communication with (i.e., connected with) the filtration groove 5 through the pipeline 15. The horizontal pipeline 8 is disposed on a bottom-right of the second partition 4, and the horizontal pipeline 8 penetrates through the second partition 4 and is in communication with the filtration groove 5. The vertical pipelines 9 are disposed on a top of the horizontal pipeline 8, an end of each vertical pipeline 9 is in communication with the horizontal pipeline 8, and the vertical pipelines 9 are perpendicular to the bottom of the box body 2. The outlet pipe 10 is in communication with a water outlet 16 of the water pump 7.

In the embodiment, a right side of the first partition 3 is filled with a modified filter material 11, specifically, a right side of the second partition 4 is filled with the modified filter material 11, an upper part of the modified filter material 11 is configured to be filled with a submerged plant, and the submerged plant is Myriophyllum verticillatum.

In the embodiment, a height of a water surface 13 of the terrarium body 1 is lower than a height of the outlet pipe 10. A top of the filtration groove 5 is provided with a detachable sealing cover plate 17, and the detachable sealing cover plate 17 is configured to replace the filtration cotton 12.

In the embodiment, the filtration assembly 6 is disposed as one group, and the outlet pipe 10 is inserted L-shaped.

In the embodiment, a preparation method of the modified filter material includes the following steps (a)-(d).

In step (a), 100 g of the maifanstone powder and 50 g of the zeolite powder are mixed evenly to obtain mixing powder. The mixing powder is soaked in 800 mL of diluted hydrochloric acid with a weight concentration of 3% for 4 h to obtain a soaked mixture. The soaked mixture is calcined at 400° C. for 3 h to obtain pretreated mixing powder.

In step (b), 50 g of the pretreated mixing powder obtained in the step (a) is added into 500 mL of deionized water, 100 g of a chitosan solution with a weight concentration of 60 g/L, 5 g of sodium bicarbonate and 2 g of γ-glycidoxypropyltrimethoxysilane are added into the deionized water added with the pretreated mixing powder for stirring to react at 50° C. for 6 h to obtain a first mixture. The first mixture is filtered and dried to obtain filter material powder.

In step (c), 100 g of the filter material powder obtained in the step (c) is mixed with 10 g of the cement evenly to obtain a second mixture. The second mixture is added into 20 g of deionized water for stirring evenly to obtain a third mixture. Granulation molding is performed on the third mixture to obtain a molded mixture. The molded mixture is roasted at 350° C. for 5 h to obtain filter material particles. The filter material particles are spherical with a particle size of 3-5 millimeters (mm).

In step (d), 50 g of the filter material particles obtained in the step (c) are added into 500 mL of compound bacterial solution. The compound bacterial solution is a mixing solution of the Bacillus subtilis and the nitrifying bacteria, and strain concentrations of the Bacillus subtilis and the nitrifying bacteria are 3×10¹⁰/mL and 1×10¹⁰/mL, respectively. The compound bacterial solution added with the filter material particles is oscillated at room temperature for 2 h to obtain an oscillated mixture. 3 g of the soluble pentosan is added into the oscillated mixture for stirring evenly, 100 g of a potassium chloride solution with a weight concentration of 4% and 1 g of pentaerythritol tetra acrylate are added into the oscillated mixture added with the soluble pentosan to obtain a fourth mixture. A crosslinking reaction is performed on the fourth mixture at 20° C. for 8 h to obtain a crosslinked mixture. The crosslinked mixture is filtered to obtain a filtered mixture. The filtered mixture is dried at the room temperature to obtain the modified filter material.

5 domestic fancy carps with healthy growth and a body length of 4-6 centimeters (cm) are selected to be placed into the water-changing-free terrarium, water quality of the water-changing-free terrarium is tested and the filtration cotton is changed every 10 days. The water quality is tested for 30 days in total, and no water change is carried out except for supplementary evaporative water. The test data is as follows.

| | 10 days | 20 days | 30 days |
|---|---|---|---|
| power of hydrogen (pH) | 6.8 | 6.9 | 6.8 |
| Total nitrogen (mg/L) | 0.72 | 0.68 | 0.73 |
| Ammonia nitrogen (mg/L) | 0.62 | 0.66 | 0.65 |
| Dissolved oxygen (mg/L) | 9.27 | 10.43 | 9.51 |
| Is there any odor | No odor | No odor | No odor |

### Embodiment 2

A water-changing-free terrarium with a pipeline type biofiltration system is provided, and the water-changing-free terrarium includes a terrarium body 1, a box body 2, a first partition 3, a second partition 4, a filtration assembly 6, and filtration cotton 12. The box body 2 is disposed in the terrarium body 1 and is fixedly connected to a bottom of the terrarium body 1. The filtration assembly 6 is disposed in the box body 2. The first partition 3 and the second partition 4 are disposed in the box body 2 and perpendicular to a bottom of the box body 2, and the first partition 3 and the second partition 4 are fixedly connected to the bottom of the box body 2. A filtration groove 5 is defined between the first partition 3 and the second partition 4, and the filtration groove 5 is provided with the filtration cotton 12 therein.

In the embodiment, the filtration assembly 6 includes: a water pump 7, a horizontal pipeline 8, vertical pipelines 9, an outlet pipe 10 and a pipeline 15. The water pump 7 is disposed on a left side of the first partition 3, and is fixedly connected to the bottom of the box body 2, and a water inlet 14 of the water pump 7 is in communication with the filtration groove 5 through the pipeline 15. The horizontal pipeline 8 is disposed on a bottom-right of the second partition 4, and the horizontal pipeline 8 penetrates through the second partition 4 and is in communication with the filtration groove 5. The vertical pipelines 9 are disposed on a top of the horizontal pipeline 8, an end of each vertical pipeline 9 is in communication with the horizontal pipeline 8, and the vertical pipelines 9 are perpendicular to the bottom of the box body 2. The outlet pipe 10 is in communication with a water outlet 16 of the water pump 7.

In the embodiment, a right side of the first partition 3 is filled with a modified filter material 11, specifically, a right side of the second partition 4 is filled with the modified filter material 11, an upper part of the modified filter material 11 is configured to be filled with a submerged plant, and the submerged plant is Potamogeton wrightii.

In the embodiment, a height of a water surface 13 of the terrarium body 1 is lower than a height of the outlet pipe 10. A top of the filtration groove 5 is provided with a detachable scaling cover plate 17, and the detachable sealing cover plate 17 is configured to replace the filtration cotton 12.

In the embodiment the filtration assembly 6 is disposed as one group, and the outlet pipe 10 is inserted L-shaped.

In the embodiment, a preparation method of the modified filter material includes the following steps (a)-(d).

In step (a), 100 g of the maifanstone powder and 200 g of the zeolite powder are mixed evenly to obtain mixing powder. The mixing powder is soaked in 800 mL of diluted hydrochloric acid with a weight concentration of 7% for 2 h to obtain a soaked mixture. The soaked mixture is calcined at 600° C. for 1 h to obtain pretreated mixing powder.

In step (b), 50 g of the pretreated mixing powder obtained in the step (a) is added into 500 mL of deionized water, 150 g of a chitosan solution with a weight concentration of 60 g/L, 8 g of sodium bicarbonate and 4 g of γ-glycidoxypropyltrimethoxysilane are added into the deionized water added with the pretreated mixing powder for stirring to react at 60° C. and for 4 h to obtain a first mixture. The first mixture is filtered and dried to obtain filter material powder.

In step (c), 100 g of the filter material powder obtained in the step (c) is mixed with 15 g of the cement evenly to obtain a second mixture. The second mixture is added into 40 g of deionized water for stirring evenly to obtain a third mixture. Granulation molding is performed on the third mixture to obtain a molded mixture. The molded mixture is roasted at 500° C. for 2 h to obtain filter material particles. The filter material particles are spherical with a particle size of 3-5 mm.

In step (d), 50 g of the filter material particles obtained in the step (c) are added into 500 mL of compound bacterial solution. The compound bacterial solution is a mixing solution of the Bacillus subtilis and the nitrifying bacteria, and strain concentrations of the Bacillus subtilis and the nitrifying bacteria are 5×10¹⁰/mL and 2×10¹⁰/mL, respectively. The compound bacterial solution added with the filter material particles is oscillated at room temperature for 4 h to obtain an oscillated mixture. 5 g of the soluble pentosan is added into the oscillated mixture for stirring evenly, 200 g of a potassium chloride solution with a weight concentration of 2% and 2 g of pentaerythritol tetra acrylate are added into the oscillated mixture added with the soluble pentosan to obtain a fourth mixture. A crosslinking reaction is performed on the fourth mixture at 30° C. for 5 h to obtain a crosslinked mixture. The crosslinked mixture is filtered to obtain a filtered mixture. The filtered mixture is dried to obtain the modified filter material.

5 domestic fancy carps with healthy growth and a body length of 4-6 cm are selected to be placed into the water-changing-free terrarium, water quality of the water-changing-free terrarium is tested and the filtration cotton is changed every 10 days. The water quality is tested for 30 days in total, and no water change is carried out except for supplementary evaporative water. The test data is as follows.

| | 10 days | 20 days | 30 days |
|---|---|---|---|
| pH | 6.8 | 6.8 | 6.9 |
| Total nitrogen (mg/L) | 0.75 | 0.72 | 0.77 |
| Ammonia nitrogen (mg/L) | 0.61 | 0.64 | 0.68 |
| Dissolved oxygen (mg/L) | 10.06 | 10.87 | 9.15 |
| Is there any odor | No odor | No odor | No odor |

### Comparative Embodiment 1

A water-changing-free terrarium with a pipeline type biofiltration system is provided, and the water-changing-free terrarium includes a terrarium body 1, a box body 2, a first partition 3, a second partition 4, a filtration assembly 6 and filtration cotton 12. The box body 2 is disposed in the terrarium body 1 and is fixedly connected to a bottom of the terrarium body 1. The filtration assembly 6 is disposed in the box body 2. The first partition 3 and the second partition 4 are disposed in the box body 2 and perpendicular to a bottom of the box body 2, and the first partition 3 and the second partition 4 are fixedly connected to the bottom of the box body 2. A filtration groove 5 is defined between the first partition 3 and the second partition 4, and the filtration groove 5 is placed with the filtration cotton 12 therein.

In the comparative embodiment, the filtration assembly 6 includes: a water pump 7, a horizontal pipeline 8, vertical pipelines 9, an outlet pipe 10 and a pipeline 15. The water pump 7 is disposed on a left side of the first partition 3, and is fixedly connected to the bottom of the box body 2, and a water inlet 14 of the water pump 7 is in communication with the filtration groove 5 through the pipeline 15. The horizontal pipeline 8 is disposed on a bottom-right of the second partition 4, and the horizontal pipeline 8 penetrates through the second partition 4 and is in communication with the filtration groove 5. The vertical pipelines 9 are disposed on a top of the horizontal pipeline 8, an end of each vertical pipeline 9 is in communication with the horizontal pipeline 8, and the vertical pipelines 9 are perpendicular to the bottom of the box body 2. The outlet pipe 10 is in communication with a water outlet 16 of the water pump 7.

In the embodiment, a right side of the first partition 3 is filled with a modified filter material 11, specifically, a right side of the second partition 4 is filled with the modified filter material 11, an upper part of the modified filter material 11 is configured to be filled with a submerged plant, and the submerged plant is Myriophyllum verticillatum.

In the embodiment, a height of a water surface 13 of the terrarium body 1 is lower than a height of the outlet pipe 10. A top of the filtration groove 5 is provided with a detachable sealing cover plate 17, and the detachable sealing cover plate 17 is configured to replace the filtration cotton 12.

In the embodiment the filtration assembly 6 is disposed as one group, and the outlet pipe 10 is inserted L-shaped.

In the embodiment, a preparation method of the modified filter material includes the following steps (a)-(c).

In step (a), 100 g of the maifanstone powder and 50 g of the zeolite powder are mixed evenly to obtain mixing powder The mixing powder is soaked in 800 mL of diluted hydrochloric acid with a weight concentration of 3% for 4 h to obtain pretreated mixing powder.

In step (b), 100 g of the pretreated mixing powder obtained in the step (a) is mixed with 10 g of the cement evenly to obtain a first mixture. The first mixture is added into 20 g of deionized water for stirring evenly to obtain a second mixture. Granulation molding is performed on the second mixture to obtain a molded mixture. The molded mixture is roasted at 350° C. for 5 h to obtain filter material particles. The filter material particles are spherical with a particle size of 3-5 mm.

In step (c), 50 g of the filter material particles obtained in the step (c) are added into 500 mL of compound bacterial solution. The compound bacterial solution is a mixing solution of the Bacillus subtilis and the nitrifying bacteria, and strain concentrations of the Bacillus subtilis and the nitrifying bacteria are 3×10¹⁰/mL and 1×10¹⁰/mL, respectively. The compound bacterial solution added with the filter material particles is oscillated at room temperature for 2 h to obtain an oscillated mixture. The oscillated mixture is filtered to obtain a filtered mixture, and the filtered mixture is dried at the room temperature to obtain the modified filter material.

5 domestic fancy carps with healthy growth and a body length of 4-6 cm are selected to be placed into the water-changing-free terrarium, water quality of the water-changing-free terrarium is tested and the filtration cotton is changed every 10 days. The water quality is tested for 30 days in total, and no water change is carried out except for supplementary evaporative water. The test data is as follows.

| | 10 days | 20 days | 30 days |
|---|---|---|---|
| pH | 6.8 | 7.0 | 7.5 |
| Total nitrogen (mg/L) | 0.81 | 1.14 | 1.52 |
| Ammonia nitrogen (mg/L) | 0.76 | 0.94 | 1.42 |
| Dissolved oxygen (mg/L) | 8.54 | 8.29 | 7.32 |
| Is there any odor | No odor | Slight odor | Noticeable odor |

It can be seen from the above data that the water-changing-free terrarium with the pipeline type biological filtration system provided by the disclosure maintains a stable range of pH, total nitrogen, ammonia nitrogen and dissolved oxygen content in the terrarium after one month, and the water has no odor, and the water quality remains clear, thus realizing purification of the water quality in the terrarium.

Although the embodiments of the disclosure have been shown and described, it will be understood by those skilled in the art that various changes, modifications, substitutions and variations can be made to these embodiments without departing from principles and spirit of the disclosure, the scope of the disclosure is defined by attached claims and their equivalents.

What is claimed is:

1. A water-changing-free terrarium with a pipeline type biofiltration system, comprising:
a terrarium body (1);
a box body (2), disposed in the terrarium body (1), and fixedly connected to a bottom of the terrarium body (1); and
a filtration assembly (6), disposed in the box body (2);
wherein the box body (2) is provided with a first partition (3) and a second partition (4) therein which are perpendicular to a bottom of the box body (2), and the first partition (3) and the second partition (4) are fixedly connected to the bottom of the box body (2); and a filtration groove (5) is defined between the first partition (3) and the second partition (4), and the filtration groove (5) is provided with filtration cotton (12) therein.

2. The water-changing-free terrarium with the pipeline type biofiltration system as claimed in claim 1, wherein the filtration assembly (6) comprises:
a water pump (7), disposed on a left side of the first partition (3), and fixedly connected to the bottom of the box body (2); wherein a water inlet (14) of the water pump (7) is in communication with the filtration groove (5) through a pipeline (15);
a horizontal pipeline (8), disposed on a bottom-right of the second partition (4); wherein the horizontal pipeline (8) penetrates through the second partition (4) and is in communication with the filtration groove (5);
a plurality of vertical pipelines (9), disposed on a top of the horizontal pipeline (8); wherein an end of each of the plurality of vertical pipelines (9) is in communication with the horizontal pipeline (8), and the plurality of vertical pipelines (9) are perpendicular to the bottom of the box body (2); and
an outlet pipe (10); wherein the outlet pipe (10) is in communication with a water outlet (16) of the water pump (7).

3. The water-changing-free terrarium with the pipeline type biofiltration system as claimed in claim 1, wherein a right side of the second partition (4) is filled with a modified filter material (11), and an upper part of the modified filter material (11) is configured to be provided with a submerged plant.

4. The water-changing-free terrarium with the pipeline type biofiltration system as claimed in claim 3, wherein a preparation method of the modified filter material (11) comprises:
(a) mixing maifanstone powder and zeolite powder evenly to obtain mixing powder, soaking the mixing powder in diluted hydrochloric acid to obtain a soaked mixture, and calcining the soaked mixture to obtain pretreated mixing powder;
(b) adding the pretreated mixing powder obtained in the step (a) into deionized water, adding a chitosan solution, sodium bicarbonate and γ-glycidoxypropyltrimethoxysilane into deionized water added with the pretreated mixing powder, stirring the deionized water added with the pretreated mixing powder, the chitosan solution, the sodium bicarbonate and the γ-glycidoxypropyltrimethoxysilane for reaction to obtain a first mixture, filtering the first mixture to obtain a first filtered mixture and drying the first filtered mixture to obtain filter material powder;
(c) mixing the filter material powder obtained in the step (b) with cement evenly to obtain a second mixture, adding the second mixture into deionized water for stirring evenly to obtain a third mixture, performing granulation molding on the third mixture to obtain a molded mixture, and roasting the molded mixture to obtain filter material particles; and
(d) adding the filter material particles obtained in the step (c) into a compound bacterial solution for oscillating at room temperature for 2-4 hours (h) to obtain an oscillated mixture, adding soluble pentosan into the oscillated mixture for stirring evenly, adding a potassium chloride solution and pentaerythritol tetra acrylate into the oscillated mixture added with the soluble pontosan to obtain a fourth mixture, performing a crosslinking reaction on the fourth mixture to obtain a crosslinked mixture, filtering the crosslinked mixture to obtain a second filtered mixture, and drying the second filtered mixture at the room temperature to obtain the modified filter material.

5. The water-changing-free terrarium with the pipeline type biofiltration system as claimed in claim 4, wherein in the step (a), a weight ratio of the maifanstone powder and the zeolite powder is in a range of 1:0.5-2; a weight concentration of the diluted hydrochloric acid is in a range of 3-7%; a period for the soaking is in a range of 2-4 h; and a temperature for the calcining is in a range of 400-600 Celsius degree (° C.), and a period for the calcining is in a range of 1-3 h.

6. The water-changing-free terrarium with the pipeline type biofiltration system as claimed in claim 4, wherein in the step (b), a weight concentration of the chitosan solution is in a range of 30-60 grams per liter (g/L); a weight ratio of the pretreated mixing powder:the chitosan solution:the sodium bicarbonate:the γ-glycidoxypropyltrimethoxysilane is in a range of 50:100-150:5-8:2-4; and a temperature for the stirring is in a range of 50-60° C., and a period for the stirring is in a range of 4-6 h.

7. The water-changing-free terrarium with the pipeline type biofiltration system as claimed in claim 4, wherein in the step (c), a weight ratio of the filter material powder: the cement: the deionized water is in a range of 10:1-1.5:2-4; and a temperature for the roasting is in a range of 350-500° C., and a period for the roasting is in a range of 2-5 h.

8. The water-changing-free terrarium with the pipeline type biofiltration system as claimed in claim 4, wherein in the step (d), the compound bacterial solution is a mixing solution of Bacillus subtilis and nitrifying bacteria, and strain concentrations of the Bacillus subtilis and the nitrifying bacteria are 3-5×10¹⁰ per milliliter (/mL) and 1-2×10¹⁰/mL, respectively; a weight concentration of the potassium chloride solution is in a range of 2-4%; a weight ratio of the filter material particles: the soluble pentosan: the potassium chloride solution: the pentaerythritol tetra acrylate is in a range of 50:3-5:100-200:1-2; and a temperature for the crosslinking reaction is in a range of 20-30° C., and a period for the crosslinking reaction is in a range of 5-8 h.

9. The water-changing-free terrarium with the pipeline type biofiltration system as claimed in claim 2, wherein a height of a water surface (13) of the terrarium body (1) is lower than a height of the outlet pipe (10); and a top of the filtration groove (5) is provided with a detachable sealing cover plate (17), and the detachable sealing cover plate (17) is configured to replace the filtration cotton (12).

10. The water-changing-free terrarium with the pipeline type biofiltration system as claimed in claim 2, wherein a number of the filtration assembly (6) is at least one, and the outlet pipe (10) is inverted L-shaped.

11. The water-changing-free terrarium with the pipeline type biofiltration system as claimed in claim 3, wherein the submerged plant comprises at least one selected from the group consisting of Myriophyllum verticillatum, Potamogeton wrightii, Vallisneria natans, and Hydrilla verticillata.

12. The water-changing-free terrarium with the pipeline type biofiltration system as claimed in claim 4, wherein the filter material particles are spherical with a particle size of 3-5 millimeters (mm).

13. A water-changing-free terrarium, comprising:
a terrarium body (1);
a box body (2), disposed in the terrarium body (1), and fixedly connected to a bottom of the terrarium body (1);
a filtration assembly (6), disposed in the box body (2);
a partition (4), disposed in the box body (2); and
a modified filter material (11), disposed in the box body (2) and located at a side of the partition (4); wherein the modified filter material (11) is configured to adsorb and decompose impurities of water in the terrarium body (1).

14. The water-changing-free terrarium as claimed in claim 13, further comprising:
another partition (3), disposed in the box body (2); wherein the another partition (3) and the partition (4) define a filtration groove (5) therebetween; and
filtration cotton (12), filled in the filtration groove (5).

15. The water-changing-free terrarium as claimed in claim 14, wherein the filtration assembly (3) comprises:
a water pump (7), disposed on a left side of the another partition (3), and fixedly connected to a bottom of the box body (2); wherein a water inlet (14) of the water pump (7) is in communication with the filtration groove (5) through a pipeline (15);
a horizontal pipeline (8), disposed on a bottom-right of the partition (4); wherein the horizontal pipeline (8) penetrates through the partition (4) and is in communication with the filtration groove (5);
a plurality of vertical pipelines (9), disposed on a top of the horizontal pipeline (8); wherein an end of each of the plurality of vertical pipelines (9) is in communication with the horizontal pipeline (8), and the plurality of vertical pipelines (9) are perpendicular to the bottom of the box body (2); and
an outlet pipe (10); wherein the outlet pipe (10) is in communication with a water outlet (16) of the water pump (7);
wherein the another partition (3) is closer to the water pump (7) relative to the partition (4).

16. The water-changing-free terrarium as claimed in claim 13, wherein a preparation method of the modified filter material (11) comprises:
(a) mixing maifanstone powder and zeolite powder evenly to obtain mixing powder, soaking the mixing powder in diluted hydrochloric acid to obtain a soaked mixture, and calcining the soaked mixture to obtain pretreated mixing powder;
(b) adding the pretreated mixing powder obtained in the step (a) into deionized water, adding a chitosan solution, sodium bicarbonate and γ-glycidoxypropyltrimethoxysilane into deionized water added with the pretreated mixing powder, stirring the deionized water added with the pretreated mixing powder, the chitosan solution, the sodium bicarbonate and the γ-glycidoxypropyltrimethoxysilane for reaction to obtain a first mixture, filtering the first mixture to obtain a first filtered mixture, and drying the first filtered mixture to obtain filter material powder;
(c) mixing the filter material powder obtained in the step (b) with cement evenly to obtain a second mixture, adding the second mixture into deionized water for stirring evenly to obtain a third mixture, performing granulation molding on the third mixture to obtain a molded mixture, and roasting the molded mixture to obtain filter material particles; and
(d) adding the filter material particles obtained in the step (c) into a compound bacterial solution for oscillating at room temperature for 2-4 h to obtain an oscillated mixture, adding soluble pentosan into the oscillated mixture for stirring evenly, adding a potassium chloride solution and pentaerythritol tetra acrylate into oscillated mixture added with the soluble pentosan to obtain a fourth mixture, performing a crosslinking reaction on the fourth mixture to obtain a crosslinked mixture, filtering the crosslinked mixture to obtain a second filtered mixture, and drying the second filtered mixture at the room temperature to obtain the modified filter material.

17. A pipeline type biofiltration system, comprising:
a box body (2); and
a filtration assembly (6), disposed in the box body (2);
a first partition (3) and a second partition (4), disposed in the box body (2) and perpendicular to a bottom of the box body (2); wherein the first partition (3) and the second partition (4) are fixedly connected to the bottom of the box body (2), and define a filtration groove (5) therebetween, and the filtration groove (5) is provided with filtration cotton (12) therein; and
a modified filter material (11), disposed in the box body (2) and located at a right side of the second partition (4); wherein the modified filter material (11) is configured to adsorb and decompose impurities in water.

18. The pipeline type biofiltration system as claimed in claim 17, wherein the filtration assembly (6) comprises:
a water pump (7), disposed on a left side of the first partition (3), and fixedly connected to the bottom of the box body (2); wherein a water inlet (14) of the water pump (7) is in communication with the filtration groove (5) through a pipeline (15);
a horizontal pipeline (8), disposed on a bottom-right of the second partition (4); wherein the horizontal pipeline (8) penetrates through the second partition (4) and is in communication with the filtration groove (5);
a plurality of vertical pipelines (9), disposed on a top of the horizontal pipeline (8); wherein an end of each of the plurality of vertical pipelines (9) is in communication with the horizontal pipeline (8), and the plurality of vertical pipelines (9) are perpendicular to the bottom of the box body (2); and
an outlet pipe (10); wherein the outlet pipe (10) is in communication with a water outlet (16) of the water pump (7).

19. The pipeline type biofiltration system as claimed in claim 17, wherein a top of the filtration groove (5) is provided with a detachable sealing cover plate (17), and the detachable sealing cover plate (17) is configured to replace the filtration cotton (12).

20. The pipeline type biofiltration system as claimed in claim 17, wherein a preparation method of the modified filter material (11) comprises:
(a) mixing maifanstone powder and zeolite powder evenly to obtain mixing powder, soaking the mixing powder in diluted hydrochloric acid to obtain a soaked mixture, and calcining the soaked mixture to obtain pretreated mixing powder;
(b) adding the pretreated mixing powder obtained in the step (a) into deionized water, adding a chitosan solution, sodium bicarbonate and γ-glycidoxypropyltrimethoxysilane into deionized water added with the pretreated mixing powder, stirring the deionized water added with the pretreated mixing powder, the chitosan solution, the sodium bicarbonate and the γ-glycidoxypropyltrimethoxysilane for reaction to obtain a first mixture, filtering the first mixture to obtain a first filtered mixture, and drying the first filtered mixture to obtain filter material powder;
(c) mixing the filter material powder obtained in the step (b) with cement evenly to obtain a second mixture, adding the second mixture into deionized water for stirring evenly to obtain a third mixture, performing granulation molding on the third mixture to obtain a molded mixture, and roasting the molded mixture to obtain filter material particles; and
(d) adding the filter material particles obtained in the step (c) into a compound bacterial solution for oscillating at room temperature for 2-4 h to obtain an oscillated mixture, adding soluble pentosan into the oscillated mixture for stirring evenly, adding a potassium chloride solution and pentaerythritol tetra acrylate into oscillated mixture added with the soluble pentosan to obtain a fourth mixture, performing a crosslinking reaction on the fourth mixture to obtain a crosslinked mixture, filtering the crosslinked mixture to obtain a second filtered mixture, and drying the second filtered mixture at the room temperature to obtain the modified filter material.
